(19) United States
(12) Patent Application Publication
(10) Pub. No.: US 2020/0386452 A1
(43) Pub. Date: Dec. 10, 2020

(54) COOLING DEVICE AND METHOD OF USING THE COOLING DEVICE

(71) Applicant: DIEHL AVIATION GILCHING GMBH, Gilching (DE)

(72) Inventors: ROBIN LANGEBACH, DRESDEN (DE); ALEXANDER JAHN, DRESDEN (DE); INGO ZERBES, MUENCHEN (DE)

(21) Appl. No.: 16/892,409

(22) Filed: Jun. 4, 2020

(30) Foreign Application Priority Data
Jun. 4, 2019 (DE) 102019003957

(51) Int. Cl. F25B 39/02; B64D 11/04; B64D 13/08; F25D 21/14

(52) U.S. Cl. CPC F25B 39/02; B64D 11/04; B64D 2013/0629; F25D 21/14; B64D 13/08

(57) ABSTRACT

A cooling device, for example, for a galley of an aircraft, has a cooling apparatus with a refrigerating medium circuit which contains a first heat exchanger for discharging heat of the refrigerating medium to an ambient air flow and a second heat exchanger for absorbing heat into the refrigerating medium from a cold air flow for the galley. Condensate, namely water, produced by the cooling apparatus or the galley is received in collection devices. The collected water can them be retrieved from the collection devices and preferably introduced in the evaporated state into the ambient air flow so that a discharge of the water in liquid form is no longer required.

### CROSS-REFERENCE TO RELATED APPLICATION

This application claims the priority, under 35 U.S.C. § 119, of German patent application DE 10 2019 003 957, filed Jun. 4, 2019; the prior application is herewith incorporated by reference in its entirety.

### BACKGROUND OF THE INVENTION

### Field of the Invention

The present invention relates to a cooling device, in particular a cooling device for a device of a vehicle which is intended to be cooled, such as, for example, a galley of a passenger aircraft.

In order to cool galleys of passenger aircraft, cooling devices (e.g. air refrigeration units, (ARUs)) in the form of compression refrigerating machines are generally used. Such compression refrigerating machines typically have a refrigerating medium circuit which contains a compressor, a high-pressure-side heat exchanger in the form of a condenser for discharging heat of the refrigerating medium to an ambient air flow, an expansion member, and a low-pressure-side heat exchanger in the form of an evaporator for absorbing heat of the refrigerating medium from a cold air flow of the device which is intended to be cooled. As a result of the cooling of the cold air flow when flowing through the evaporator, the air moisture which is contained in the cold air flow condenses and when falling below freezing point accumulates in the form of ice on the cold evaporator surfaces. Since the cooling power of the evaporator is thereby reduced, defrosting cycles are regularly carried out, in which the condensate water which is discharged is collected in a collection container. The condensate water which is collected in the collection container is then generally discharged via gravitational force via drainage ports into a drain which in particular in the application field of aircraft is technically very complex. In addition to the cooling device, generally in the galley as a result of damp air flows along cold surfaces condensate water which can then be discharged into a collection region/container in the galley is produced. Furthermore, as a result of other cooling devices or devices in the region of the galley, condensate water or waste water which is discharged into a collection container can also be produced.

### SUMMARY OF THE INVENTION

An object of the invention is to provide an improved measure for discharging water which is received in collection devices.

This object is achieved with a cooling device having the features of the independent claim. Particularly advantageous embodiments and developments of the invention are set out in the dependent claims.

The cooling device of the invention has a cooling apparatus having a refrigerating medium circuit which contains a first heat exchanger for discharging heat of the refrigerating medium to an ambient air flow and a second heat exchanger for absorbing heat of the refrigerating medium from a cold air flow of a device which is intended to be cooled and at least one first collection device for receiving water. The cooling device according to the invention further has at least one component which is selected from a conveyor unit for conveying water from one of the at least one first collection device into the ambient air flow of the cooling apparatus and a suction unit for drawing water from at least one second collection device for receiving water from other apparatuses or devices into one of the at least one first collection device.

According to the invention, there is proposed a cooling device by which using a conveyor unit water which is received in collection devices (for example, water or condensate water from the cooling apparatus of the device which is intended to be cooled or other apparatuses or devices) can be collected and can be directed into the ambient air flow upstream of the first heat exchanger of the cooling apparatus or the warm ambient air flow downstream of the first heat exchanger of the cooling apparatus. Thus, the water no longer has to be discharged as liquid, but instead is further processed inside the system. When used in galleys of passenger aircraft, complex constructions for discharging water through base plates or similar arrangements can thus be prevented. Another advantage is that, as a result of the water, a humidification of the ambient air flow takes place. The humidified ambient air flow may, for example, be supplied to the cabin air or a waste air shaft.

Alternatively or preferably additionally, the cooling device according to the invention contains a suction unit by which water which occurs or is produced in other apparatuses or devices and which has been collected in a second collection device is drawn into one of the first collection devices. The use of such a suction unit is particularly advantageous if the second collection device is located in the vicinity of the floor and therefore the water cannot run off by means of gravitational force into another (for example, central) collection container. As a result of the suction of the water of other apparatuses or devices into one of the first collection devices, the quantities of water present are combined and can then be discharged together. The technical measures can thereby be significantly improved in comparison with separately discharging the different quantities of water. If the suction unit is provided in addition to the conveyor unit, the water quantities from the first collection devices and from the second collection devices can be introduced into the ambient air flow.

In both, alternative or combined variants, the cooling device in addition to its basic function for cooling a cold air flow of a device which is intended to be cooled has an additional function of discharging water. As a result of the multifunctional cooling device, additional devices or measures for discharging water can be dispensed with and/or disadvantages as a result of excessive quantities of water in the collection devices can be prevented. The cooling device preferably forms together with the conveyor unit and/or the suction unit a structural unit so that the assembly operation can be simplified and no or at most a small modification of the device which is intended to be cooled is required.

The at least one first collection device generally serves to absorb water. Preferably, at least one of the at least one first collection devices serves to receive water from the cooling apparatus, in particular condensate water which is produced by the cooling apparatus during de-frosting cycles. The at least one second collection device serves to receive water from other apparatuses or devices, such as, for example, other cooling apparatuses or the device which is intended to be cooled by the cooling apparatus (for example, galley of a vehicle, in particular aircraft). This is, for example, condensate water or waste water which is produced by the respective other apparatus or the respective other device.

The cooling apparatus of the cooling device is preferably constructed as a compression refrigerating machine having a refrigerating medium circuit which contains a compactor or compressor. The first heat exchanger is preferably a high-pressure-side heat exchanger in the form of a liquefier or condenser; the second heat exchanger is preferably a low-pressure-side heat exchanger in the form of an evaporator.

The first and second collection devices are preferably arranged in such a manner that the water runs into them by means of gravitational force or an air flow. Preferably, drip edges which direct the water to the collection device may be provided. Particularly suitable are the lowest points of the device which is intended to be cooled, that is to say, for example, the galley or a region of the galley or a trolley in the galley.

In an embodiment of the invention, there are provided a plurality of collection containers (first and second collection devices) for receiving (condensate) water from part-regions of the cooling device or the device which is intended to be cooled and at least one central collection container as a first collection device for receiving water from the plurality of collection containers. The central collection container may selectively be arranged inside the cooling apparatus or inside the device which is intended to be cooled.

The conveyor unit preferably has at least one suction channel which is connected to the first collection device and at least one pump (for example, diaphragm pump). The pump may, for example, be fitted inside or outside the cooling apparatus. The energy supply of the pump(s) is preferably provided by the cooling apparatus, in particular also for pumps which are arranged outside the cooling apparatus.

The suction unit preferably has at least one suction channel which is connected to the second collection device, and at least one pump (for example, diaphragm pump). The pump may, for example, be fitted inside or outside the cooling apparatus. The energy supply of the pump(s) is preferably provided by the cooling apparatus, in particular also for pumps which are arranged outside the cooling apparatus.

Preferably, the cooling device further has at least one first sensor (for example, fluid level sensor or moisture rate sensor) for detecting a water quantity in the at least one first collection device and/or at least one second sensor (for example, fluid level sensor or moisture rate sensor) for detecting a water quantity in the at least one second collection device. In this instance, the conveyor unit (in particular the pump thereof) and the suction unit (in particular the pump thereof) are preferably operated in accordance with the quantity of water detected in each case.

In a preferred embodiment of the invention, the conveyor unit is provided with an evaporation unit for evaporating the water before or when it is introduced into the ambient air flow. As a result of the transfer of the water into the gaseous aggregation state, the introduction into the ambient air flow can be carried out more efficiently.

For the transfer of the water into the gaseous aggregation state, different construction variants of the evaporation unit are possible. The evaporation unit preferably contains one or more of the following components:

a) a spray device for introducing the water into the ambient air flow downstream of the first heat exchanger;
b) a heating element for heating the water before it is introduced into the ambient air flow downstream of the first heat exchanger;
c) a heat exchanger for absorbing the heat of the water from the refrigerating medium circuit of the cooling apparatus, preferably from the compressor of the refrigerating medium circuit, before it is introduced into the ambient air flow downstream of the first heat exchanger;
d) for the water, an open container (for example, drip tray) over which the ambient air flow flows downstream or upstream of the first heat exchanger; and
e) a spray device for introducing the water into the ambient air flow upstream of the first heat exchanger.

The measures for heating the water before it is introduced into the ambient air flow are in this instance preferably only selected when it is introduced downstream of the first heat exchanger.

Embodiments of the invention may contain from the components listed above one individual component or any combination of two or more of these components. In this instance, in the context of the invention, there are also conceivable in particular embodiments in which the water is introduced into the ambient air flow both upstream of the first heat exchanger and downstream of the first heat exchanger.

Depending on the construction variant of the evaporation unit, different additional advantages of the cooling device can be achieved. In the case of introducing the water into the ambient air flow upstream of the first heat exchanger, the ambient air flow is cooled by adiabatic evaporation, which can increase the efficiency of the first heat exchanger and consequently the entire cooling apparatus. In the case of thermal absorption of the water from the refrigerating medium circuit, preferably from the compressor of the refrigerating medium circuit, a cooling effect for the refrigerating medium circuit or the compressor thereof is achieved, which can also increase the efficiency of the entire cooling apparatus.

In an embodiment of the invention, the at least one first collection device has a central collection container in the device which is intended to be cooled. The central collection container is preferably connected to the conveyor unit and/or a water drain. Preferably, the at least one first collection device further has in or on the cooling apparatus at least one cooling apparatus collection container which is connected to the central collection container via a drainage channel in order to allow (condensate) water to be discharged from the cooling apparatus collection container, preferably by means of gravitational force, into the central collection container. In this embodiment, the suction unit preferably draws water from the at least one second collection device into the cooling apparatus collection container or the central collection container.

In an embodiment of the invention, the at least one first collection device has in or on the cooling apparatus at least one cooling apparatus collection container which is connected to the conveyor unit and/or a water drain. In this embodiment, the suction unit preferably draws water from the at least one second collection device into the cooling apparatus collection container or the central collection container, if also provided.

The energy supply for the conveyor unit and/or the suction unit are preferably provided by the cooling apparatus. In this instance, the conveyor unit may have a pump inside or outside the cooling apparatus and the cooling apparatus, if the pump is arranged externally, may have an energy supply for the pump of the conveyor unit. This promotes the formation of the structural unit of the cooling apparatus together with the conveyor unit. In a similar manner, the suction unit may have a pump inside or outside the cooling apparatus and the cooling apparatus, if the pump is arranged externally, may have an energy supply for the pump of the suction unit, whereby the formation of the structural unit of the cooling apparatus is conveyed together with the suction unit.

The above-described cooling device of the invention can be used in a particularly advantageous manner for a device of a vehicle which is intended to be cooled, in particular an aircraft, in particular for a galley of an aircraft. However, the invention is not limited to this application.

Other features which are considered as characteristic for the invention are set forth in the appended claims.

Although the invention is illustrated and described herein as embodied in a cooling device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of structure of a cooling device according to a first embodiment of the invention;

FIG. 2 is an illustration of the structure of the cooling device according to a second embodiment of the invention;

FIG. 3 is an illustration of the structure of the cooling device according to a third embodiment of the invention;

FIG. 4 is an illustration of the structure of the cooling device according to a fourth embodiment of the invention;

FIG. 5 is an illustration of the structure of the cooling device according to a fifth embodiment of the invention;

FIG. 6 is an illustration of the structure of the cooling device according to a sixth embodiment of the invention;

FIG. 7 is an illustration of the structure of the cooling device according to a seventh embodiment of the invention;

FIG. 8 is an illustration of the structure of the cooling device according to an eighth embodiment of the invention; and

FIG. 9 is an illustration of the structure of the cooling device according to a ninth embodiment of the invention.

### DETAILED DESCRIPTION OF THE INVENTION

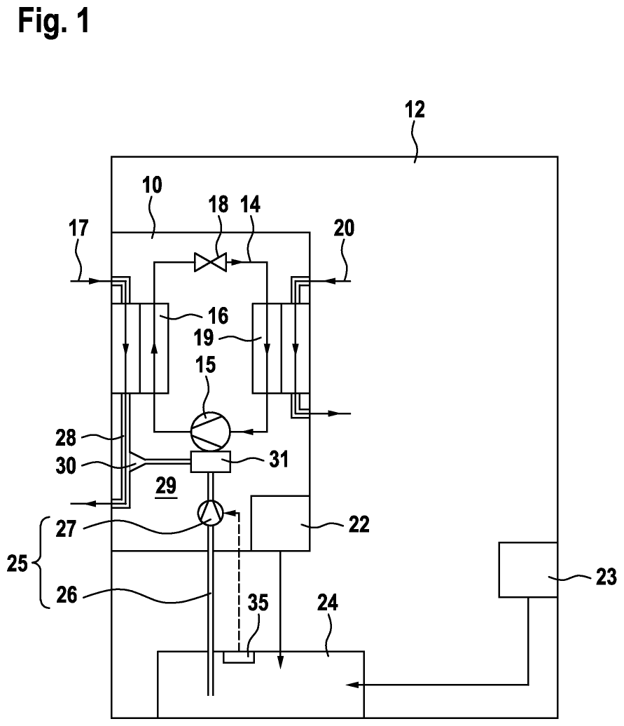

With reference to FIG. 1, the structure and function of a first embodiment of a cooling device according to the invention are described in greater detail.

The cooling device contains in particular a cooling apparatus 10 for a device 12 which is intended to be cooled. The device 12 which is intended to be cooled is, for example, a galley of a passenger aircraft or a galley region or a trolley.

In the embodiment of FIG. 1, the cooling apparatus 10 is constructed, for example, as a compression refrigerating machine. The cooling apparatus 10 has in particular a refrigerating medium circuit 14 for a refrigerating medium (for example, R134a), which has a compactor or a compressor 15, a high-pressure-side heat exchanger in the form of a liquefier or condenser (a heat exchanger of the invention) 16, an expansion member (for example, expansion valve or throttle) 18 and a low-pressure-side heat exchanger in the form of an evaporator (second heat exchanger of the invention) 19. The gaseous refrigerating medium is first compressed in the compressor 15 and then liquefied in the first heat exchanger 16 while discharging heat to an ambient air flow 17. Subsequently, the liquefied refrigerating medium is depressurised by the expansion member 18. In the subsequent second heat exchanger 19, the refrigerating medium evaporates with thermal absorption at low temperature in order to then be compressed again in the compressor 15. The second heat exchanger 19 is in heat exchange with a cold air flow 20 in order to cool the device 12 which is intended to be cooled by means of the thermal absorption of the refrigerating medium.

The cooling device is further provided with a cooling apparatus collection container (first collection device in the context of the invention) 22 in or on the cooling apparatus 10 in which a condensate water produced by the cooling apparatus 10 can be discharged and collected. The condensate water is produced, for example, on the cold surfaces of the second heat exchanger 19 by the air moisture contained in the cold air flow and is then defrosted in defrosting cycles of the cooling apparatus 10 and directed into the cooling apparatus collection container 22. The cooling apparatus collection container 22 is, for example, fitted in the vicinity of the base of the second heat exchanger 19 or the cooling apparatus 10.

The cooling device is further provided with a cooling device collector (second collection device in the context of the invention) 23 in or on the galley 12 in which a condensate water or waste water which is produced in/on the galley 12 can be discharged and collected. The condensate water is produced, for example, on cold surfaces of the galley 12 as a result of moist air, which flows into the galley, for example, as a result of leakages or frequent opening of the doors.

The two collection containers 22, 23 are connected to a central collection container (first collection device in the context of the invention) 24 into which the (condensate) water from the cooling apparatus collection container 22 and the cooling device collector 23 runs as a result of gravitational force and in which it is then temporarily stored.

As illustrated in FIG. 1, the cooling apparatus 10 is further provided with a conveyor unit 25. This conveyor unit 25 has a suction channel (for example, hose) 26 which is connected, on the one hand, to the central collection container 24 and, on the other hand, to an ambient air channel 28 of the cooling apparatus 10. The conveyor unit 25 further has a pump (for example, diaphragm pump) 27 in order to convey water from the central collection container 24 into the ambient air flow 17. The pump 27 is in this embodiment arranged inside the cooling apparatus 10 and is provided with energy by the cooling apparatus 10.

In the embodiment of FIG. 1, the central collection container 24 is provided with a first sensor (for example, fluid level sensor) 35 in order to detect the quantity of water in the central collection container 24. The pump 27 of the conveyor unit 25 is always activated when the quantity of water in the central collection container 24 exceeds a predetermined limit value. Alternatively, it is also possible to dispense with the first sensor 35 and the pump 27 can convey the water continuously or periodically at predetermined time intervals.

The cooling apparatus 10 is further provided with an evaporation unit 29. The evaporation unit 29 is provided in order to transfer the water which is conveyed from the pump 27 through the suction channel 26 in the direction towards the ambient air channel 28 into a gaseous aggregation state.

In the embodiment of FIG. 1, the evaporation unit 29 contains a spray device (for example, small nozzle) 30 for introducing the water into the ambient air flow 17 downstream of the first heat exchanger 16 and a heat exchanger 31 in contact with the compressor 15 of the refrigerating medium circuit 14. Through the heat exchanger 31, some thermal energy is supplied to the water before it is injected into the ambient air channel 28 in order to be mixed with the ambient air flow 17 and heated further. There is preferably produced a one hundred percent evaporation of the water so that the ambient air flow 17 discharges the water as increased air humidity, for example, into the cabin air of the aircraft. Furthermore, the compressor 15 of the refrigerating medium circuit 14 is slightly cooled by the heat exchanger 31, whereby the efficiency of the refrigerating medium circuit 14 can be increased. As a result of the introduction of the water into the warm, dry ambient air flow 17, this air flow is moistened and may, for example, be directed to the cabin air.

In this construction of the cooling device, in which the collected water is brought (back) from the cooling apparatus 10 and then transferred into the gaseous aggregation state, in order to introduce it into the ambient air flow, a structurally complex water drain leading, for example, from the aircraft can be dispensed with.

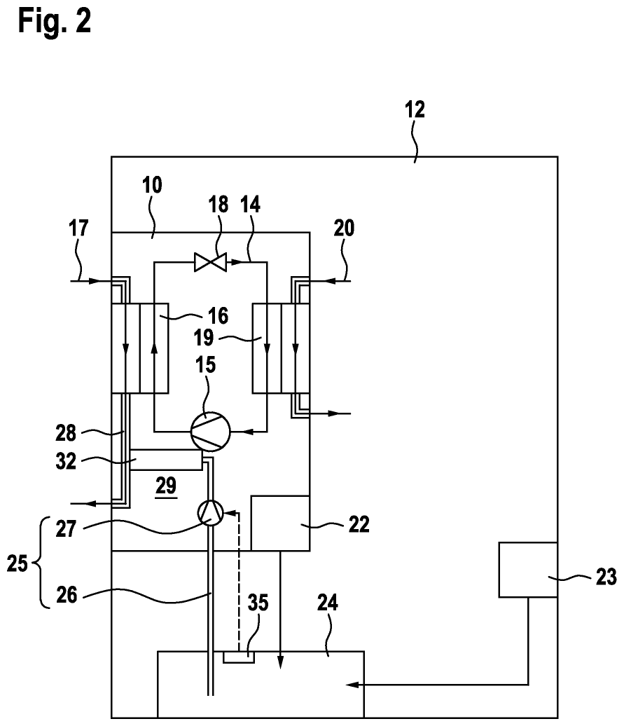

FIG. 2 shows a second embodiment of a cooling apparatus according to the invention. In this instance, identical or corresponding components are given the same reference numerals as in the first embodiment.

The cooling apparatus of FIG. 2 differs from that of the first embodiment in particular as a result of the embodiment of the evaporation unit 29. As illustrated in FIG. 2, the evaporation unit 29 has in this embodiment an open container 32, which is coupled, on the one hand, thermally to the compressor 15 of the refrigerating medium circuit 14 and, on the other hand, is open in the direction towards the ambient air channel 28. As a result of the heat exchange with the compressor 15, thermal energy is supplied to the water in order to evaporate it before it is carried away by the ambient air flow 17. As a result of the heat exchange, the compressor 15 of the refrigerating medium circuit 14 is further slightly cooled, whereby the efficiency of the refrigerating medium circuit 14 can be increased.

Otherwise, the structure and function of the cooling device of FIG. 2 correspond to those of the first embodiment of FIG. 1.

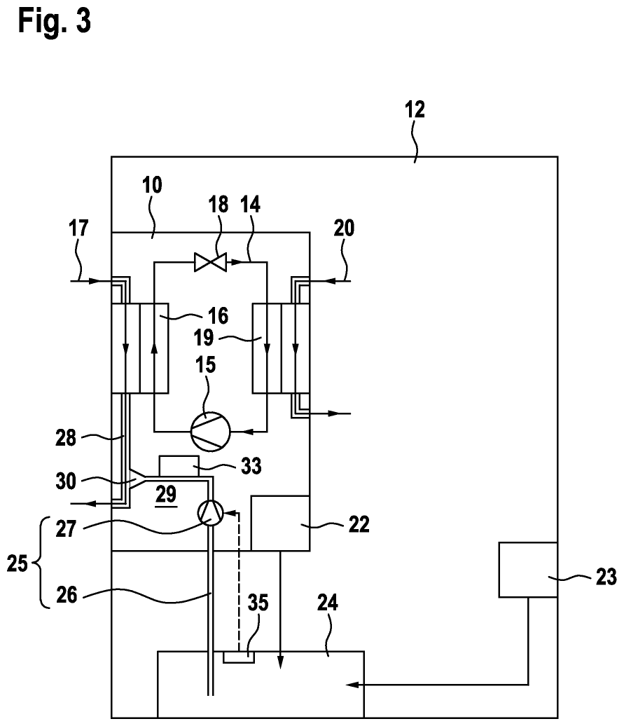

FIG. 3 shows a third embodiment of a cooling device according to the invention. In this instance, identical or corresponding components are given the same reference numerals as in the first embodiment.

The cooling device of FIG. 3 differs from that of the first embodiment in particular as a result of the embodiment of the evaporation unit 29. As illustrated in FIG. 3, the evaporation unit 29 has in this embodiment in addition to the spray device 30 an additional heating element (for example, electrical heating element, heating cartridge) 33 in order to sufficiently heat the water conveyed by the pump 27, for example, in accordance with the principle of a continuous evaporator and to ensure evaporation. The heating element 33 is preferably arranged downstream of the pump 27. There is preferably produced a one hundred percent evaporation of the water so that the ambient air flow 17 discharges the water as increased air humidity, for example, into the cabin air of the aircraft.

Otherwise, the structure and function of the cooling device of FIG. 3 correspond to those of the first embodiment of FIG. 1.

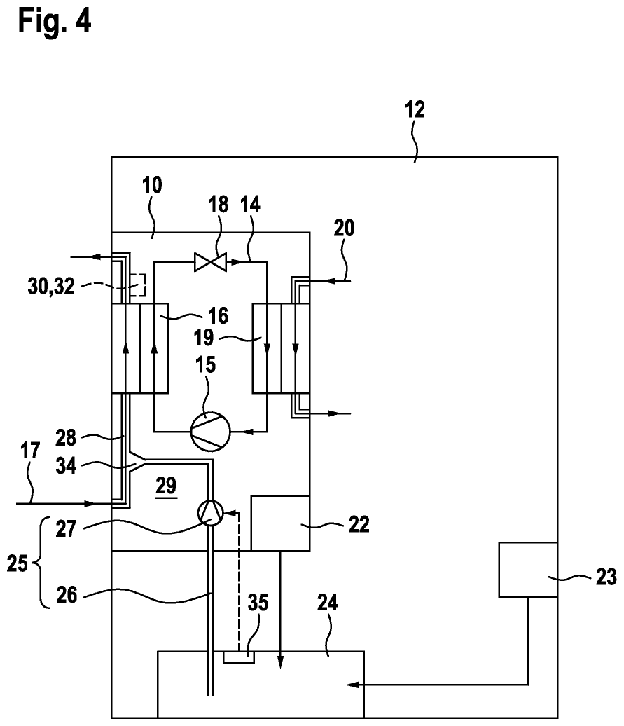

FIG. 4 shows a fourth embodiment of a cooling device according to the invention. In this instance, identical or corresponding components are given the same reference numerals as in the first embodiment.

The cooling device of FIG. 4 also differs from that of the previous embodiments as a result of the embodiment of the evaporation unit 29. As illustrated in FIG. 4, the evaporation unit 29 has in this embodiment a spray device 34 in order to introduce the water conveyed by the pump 27 upstream of the first heat exchanger 16 (the flow direction of the ambient air flow 17 is in FIG. 4 the opposite to that of FIGS. 1 to 3) into the ambient air channel 28. As a result of the introduction of the water into the ambient air flow 17 upstream of the first heat exchanger 16, the ambient air flow 17 is cooled by adiabatic evaporation, wherein in addition the efficiency of the first heat exchanger 16 and consequently the entire refrigerating medium circuit 14 can be increased.

Otherwise, the structure and function of the cooling device of FIG. 4 correspond to those of the first embodiment of FIG. 1.

The embodiments of FIGS. 1 to 4 may also be freely combined with each other. In particular, the different construction variants of the evaporation unit 29 can be freely combined with each other. For example, the evaporation units 29 of the cooling devices of FIGS. 1 and 2 may also be additionally provided with a heating element 33 according to the construction variant of FIG. 3. For example, the introduction of the water into the ambient air flow 17 upstream of the first heat exchanger 16 can also be combined with the introduction of the water into the ambient air flow 17 downstream of the first heat exchanger 16, as indicated in the embodiment of FIG. 4 as a result of the optional components 30, 32 downstream of the first heat exchanger 16 which can be provided in addition to the evaporation unit 29 upstream of the first heat exchanger 16 and which can be connected by means of the same conveyor unit 25 or another conveyor unit to the central collection container 24.

In the embodiments of FIGS. 1 to 4, the conveyor unit 25 is in each case connected to the central collection container 24 in order to convey condensate water produced by the cooling apparatus 10 and condensate water produced by the galley 12 or waste water into the ambient air flow 17. In other embodiments of the invention, the conveyor unit 25 may also be connected to the cooling apparatus collection container 22 in order to convey the condensate water produced by the cooling apparatus 10 into the ambient air flow 17. In this instance, the condensate water or waste water produced by the galley 12 runs out of the cooling device collector 23 into the central collection container 24 and can be discharged therefrom in liquid form or the water from the cooling device collector 23 can be discharged directly from the aircraft in liquid form.

In the embodiments of FIGS. 1 to 4, the water runs from the cooling device collector 23 in each case by means of gravitational force into the central collection container 24. However, if the cooling device collector 23 is located in the vicinity of the floor of the galley 12, this is not possible and the water either has to be drawn from the cooling device collector 23 or discharged directly from the aircraft in liquid form.

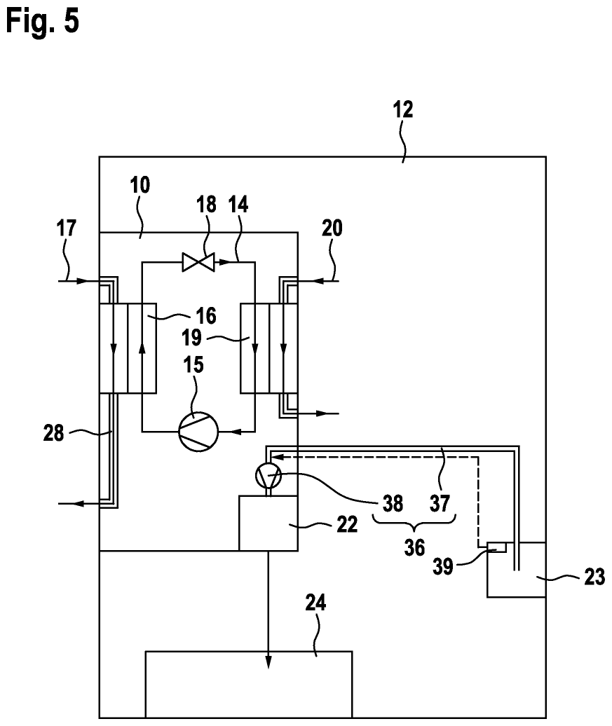

FIG. 5 shows a fifth embodiment of a cooling device according to the invention. In this instance, identical or corresponding components are given the same reference numerals as in the previous embodiments.

The cooling device of FIG. 5 differs from that of the previous embodiments in particular in that no conveyor unit 25 is provided, but instead a suction unit 36. This suction unit 36 has a suction channel (for example, hose) 37 which, on the one hand, is connected to a cooling device collector 23 which is positioned, for example, in the vicinity of the floor of the galley 12 and, on the other hand, to a cooling apparatus collection container 22 of the cooling apparatus which is positioned higher. The suction unit 36 further has a pump (for example, diaphragm pump) 38 in order to draw the (condensate) water produced by the galley 12 from the cooling device collector 23 into the cooling apparatus collection container 22, which also receives the condensate water produced by the cooling apparatus 10. The pump 38 is in this embodiment arranged inside the cooling apparatus 10 and is provided with energy by the cooling apparatus 10. Furthermore, the cooling device collector 23 is provided with a second sensor (for example, fluid level sensor) 39 in order to detect the quantity of water. The pump 38 of the suction unit 36 is always activated when the quantity of water in the cooling device collector 23 exceeds a predetermined limit value. Alternatively, it is also possible to dispense with the second sensor 39 and the pump 38 can convey the water continuously or periodically at predetermined time intervals.

The condensate water of the cooling apparatus 10 received in the cooling apparatus collection container 22 and the water of the galley 12 drawn by means of the suction unit 36 into the cooling apparatus collection container 22 can then run off together by means of gravitational force into the central collection container 24. From this, the water can then be discharged, for example, in liquid form, via drainage ports.

The cooling apparatus 10 otherwise corresponds in terms of structure and operation to the cooling apparatus of the previous embodiments of FIGS. 1 to 4.

Alternatively or additionally to the cooling device collector 23, the suction unit 36 may also be connected to another second collection device for receiving water (for example, condensate water or waste water) from other cooling devices, such as, for example, other cooling apparatuses, in order to direct the water which has been collected therein via the cooling apparatus collection container 22 into the central collection container 24.

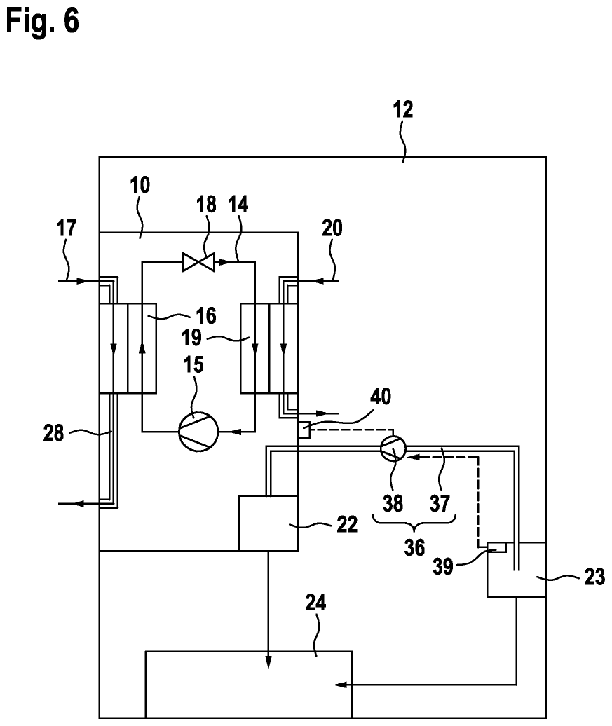

FIG. 6 shows a sixth embodiment of a cooling device according to the invention. In this instance, identical or corresponding components are given the same reference numerals as in the fifth embodiment.

The cooling device of FIG. 6 differs from that of the fifth embodiment in that the pump 38 of the suction unit 36 is arranged outside the cooling apparatus 10. In this embodiment, the cooling apparatus 10 has an energy supply 40 for the external pump 38.

Otherwise, the structure and function of the cooling device of FIG. 6 correspond to those of the fifth embodiment of FIG. 5.

In the two embodiments of FIGS. 5 and 6, the water is drawn from the cooling device collector 23 by the suction unit 36 in each case into the cooling apparatus collection container 22. In other embodiments of the invention, the suction unit 36 may also be configured in such a manner that it draws the water from the cooling device collector 23 into the central collection container 24.

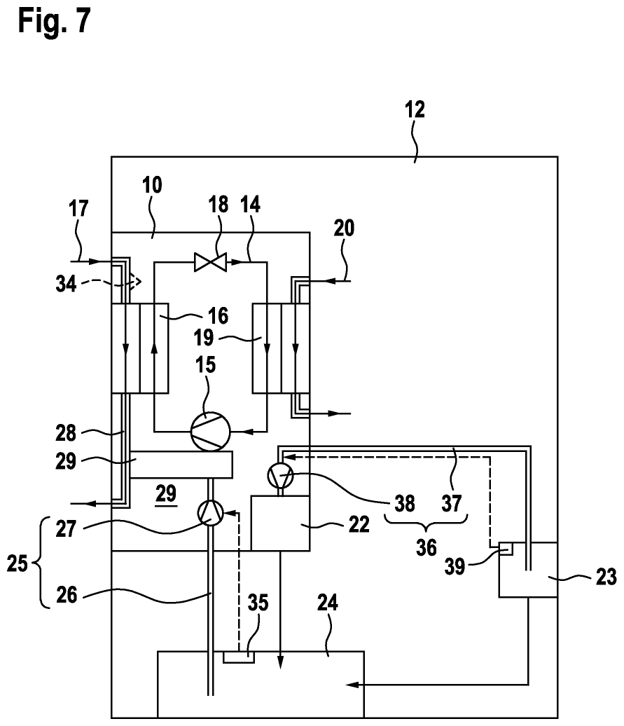

FIG. 7 shows a seventh embodiment of a cooling device according to the invention. In this instance, the same or corresponding components are given the same reference numerals as in the previous embodiments.

The cooling device of FIG. 7 is a combination of the embodiments of FIGS. 1 to 3 with the embodiment of FIG. 5. That is to say, the cooling device has both a conveyor unit 25 with an evaporation unit 29 downstream of the first heat exchanger 16 and a suction unit 36 for drawing water from the cooling device collector 23 into the cooling apparatus collection container 22. The evaporation unit 29 is indicated generally in FIG. 7 and may in particular be constructed in accordance with one of the embodiments of FIGS. 1 to 3.

Alternatively or additionally, the embodiment of FIG. 5 may also be combined with the fourth embodiment of FIG. 4, as indicated in the embodiment of FIG. 7 by the optional spray device 34 upstream of the first heat exchanger 16 which can be provided in addition to the evaporation unit 29 downstream of the first heat exchanger 16 and can be connected to the central collection container 24 via the same conveyor unit 25 or an additional conveyor unit.

As another alternative of the invention, the embodiment of FIG. 6 may also be combined with the embodiments of FIGS. 1 to 4, that is to say, the pump 38 of the suction unit 36 in contrast to the embodiment of FIG. 7 may be arranged outside the cooling apparatus 10.

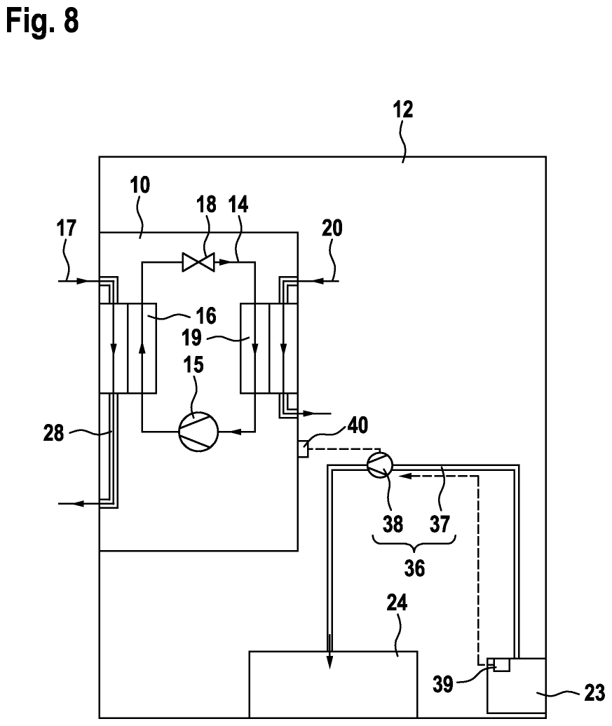

FIG. 8 shows an eighth embodiment of a cooling device according to the invention. In this instance, identical or corresponding components are given the same reference numerals as in the fifth embodiment.

The cooling device of FIG. 8 differs from that of the sixth embodiment in that the suction unit 36 draws the water from the cooling device collector 23 not into a cooling apparatus collection container 22, but instead directly into the central collection container 24. In this embodiment, the pump 38 of the suction unit 36 is preferably arranged outside the cooling apparatus 10.

Otherwise, the structure and function of the cooling device of FIG. 8 correspond to those of the sixth embodiment of FIG. 6.

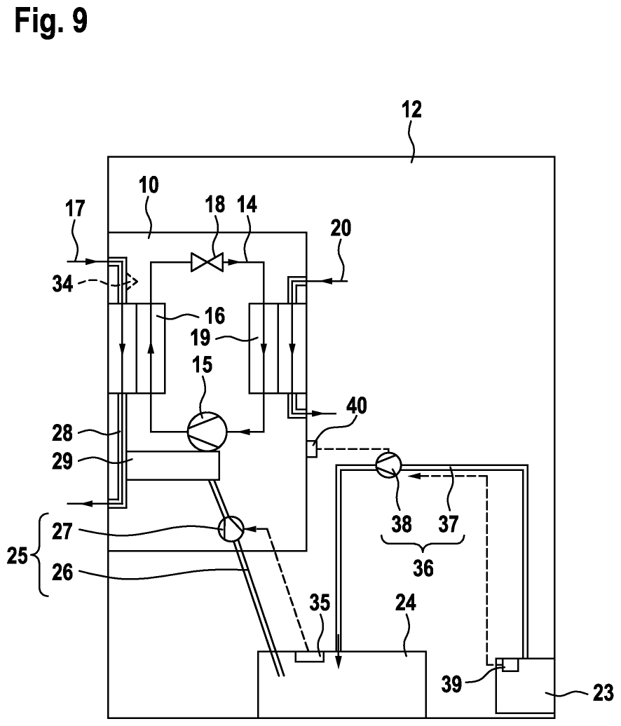

FIG. 9 shows a ninth embodiment of a cooling device according to the invention. In this instance, identical or corresponding components are given the same reference numerals as in the previous embodiments.

The cooling device of FIG. 9 is a combination of the embodiments of FIGS. 1 to 3 with the embodiment of FIG. 8. That is to say, the cooling device has both a conveyor unit 25 with an evaporation unit 29 downstream of the first heat exchanger 16 and a suction unit 36 for drawing water from the cooling device collector 23 into the cooling apparatus collection container 22. The evaporation unit 29 is generally indicated in FIG. 7 and may in particular be constructed in accordance with one of the embodiments of FIGS. 1 to 3.

Alternatively or additionally, the embodiment of FIG. 8 may also be combined with the fourth embodiment of FIG. 4, as indicated in the embodiment of FIG. 9 by the optional spray device 34 upstream of the first heat exchanger 16 which is provided in addition to the evaporation unit 29 downstream of the first heat exchanger 16 and which can be connected via the same conveyor unit 25 or another conveyor unit to the central collection container 24.

As other alternatives of the invention, the cooling devices illustrated in FIGS. 8 and 9 may additionally have a cooling apparatus collection container 22 in or on the cooling apparatus 10 from which the (condensate) water can run out of the cooling apparatus 10 via a drainage channel into the central collection chamber 24.

### LIST OF REFERENCE NUMERALS

10 Cooling apparatus, in particular compression refrigerating machine
12 Device to be cooled, for example, galley of an aircraft
14 Refrigerating medium circuit
15 Compactor or compressor
16 First heat exchanger (liquefier/condenser)
17 Ambient air flow
18 Expansion member
19 Second heat exchanger (evaporator)
20 Cold air flow
22 Cooling apparatus collection container
23 Cooling device collector
24 Central collection container
25 Conveyor unit
26 Suction channel
27 Pump
28 Ambient air channel
29 Evaporation unit
30 Spray device
31 Heat exchanger
32 Open container
33 Heating element
34 Spray device
35 First sensor
36 Suction unit
37 Suction channel
38 Pump
39 Second sensor
40 Energy supply

1. A cooling device, comprising:
a cooling apparatus containing a refrigerating medium circuit having a first heat exchanger for discharging heat from a refrigerating medium to an ambient air flow and a second heat exchanger for absorbing heat into the refrigerating medium from a cold air flow for a device which is intended to be cooled;
at least one first collection device for receiving water;
at least one second collection device; and
at least one component selected from the group consisting of a conveyor unit for conveying the water from one of said at least one first collection device into the ambient air flow of said cooling apparatus and a suction unit for drawing the water from said at least one second collection device for receiving the water from other apparatuses or devices into said one of said at least one first collection device.

2. The cooling device according to claim 1, wherein said conveyor unit has an evaporation unit for evaporating the water before or when it is introduced into the ambient air flow.

3. The cooling device according to claim 2, wherein said evaporation unit has a spray device for introducing the water into the ambient air flow downstream of said first heat exchanger.

4. The cooling device according to claim 2, wherein said evaporation unit has a heating element for heating the water or a heat exchanger for thermal absorption of the water from said refrigerating medium circuit of said cooling apparatus before the water is introduced into the ambient air flow downstream of said first heat exchanger.

5. The cooling device according to claim 2, wherein said evaporation unit has for the water an open container, over which the ambient air flow flows.

6. The cooling device according to claim 2, wherein said evaporation unit has a spray device for introducing the water into the ambient air flow upstream of said first heat exchanger.

7. The cooling device according to claim 1, further comprising at least a first sensor for detecting a quantity of the water in said at least one first collection device, wherein said conveyor unit can be operated in accordance with the quantity of the water detected by said at least one first sensor.

8. The cooling device according to claim 1, further comprising at least a second sensor for detecting a quantity of the water in said at least one second collection device, wherein said suction unit can be operated in accordance with the quantity of the water detected by said second sensor.

9. The cooling device according to claim 1, wherein said at least one first collection device has a central collection container which is intended to be cooled, said central collection container is connected to said conveyor unit or a water drain.

10. The cooling device according to claim 9, wherein said at least one first collection device further has in or on said cooling apparatus a cooling apparatus collection container which is connected to said central collection container via a drainage channel in order to allow the water to be discharged from said cooling apparatus collection container into said central collection container.

11. The cooling device according to claim 1, wherein said at least one first collection device has in or on said cooling apparatus a cooling apparatus collection container which is connected to said conveyor unit or a water drain.

12. The cooling device according to claim 10, wherein said suction unit is configured to draw the water from said at least one second collection device into said cooling apparatus collection container or said central collection container.

13. The cooling device according to claim 1, wherein said at least one second collection device has a collection device for receiving condensate water or water produced by the cooling device which is intended to be cooled and/or a collection device for receiving the condensate water or the water produced by another cooling apparatus.

14. The cooling device according to claim 1, wherein:
said conveyor unit has a pump disposed either inside said cooling apparatus or outside said cooling apparatus; and
said cooling apparatus has an energy supply for said pump of said conveyor unit.

15. The cooling device according to claim 1, wherein:
said suction unit has a pump disposed either inside said cooling apparatus or outside said cooling apparatus; and
said cooling apparatus has an energy supply for said pump of said suction unit.

16. A method of using a cooling device, which comprises the steps of:
providing the cooling device, containing:
a cooling apparatus containing a refrigerating medium circuit having a first heat exchanger for discharging heat of a refrigerating medium to an ambient air flow and a second heat exchanger for absorbing heat into the refrigerating medium from a cold air flow for a vehicle which is intended to be cooled;
at least one first collection device for receiving water;
at least one second collection device; and
at least one component selected from the group consisting of a conveyor unit for conveying the water from one of the at least one first collection device into the ambient air flow of the cooling apparatus and a suction unit for drawing the water from the at least one second collection device for receiving the water from other apparatuses or devices into one of the at least one first collection device; and
cooling an area of the vehicle which is intended to be cooled using the cooling device.

17. The method according to claim 16, wherein the area to be cooled is a galley of an aircraft.
